(19) United States
(12) Patent Application Publication
(10) Pub. No.: US 2020/0259826 A1
(43) Pub. Date: Aug. 13, 2020

(54) SYSTEM AND METHOD FOR SMART SIGN-IN AND REGISTRATION

(71) Applicant: SCBA, LLC, Philadelphia, PA (US)

(72) Inventor: Joseph Marrone, Philadelphia, PA (US)

(21) Appl. No.: 16/781,614

(22) Filed: Feb. 4, 2020

Related U.S. Application Data
(60) Provisional application No. 62/800,826, filed on Feb. 4, 2019.

(51) Int. Cl. H04L 29/06; G06F 40/211; H04L 12/58; G06F 3/048

(52) U.S. Cl. CPC H04L 63/0861; G06F 40/211; H04L 51/046; G06F 3/048; H04L 51/02

(57) ABSTRACT

A system having processors and memory devices with instructions stored thereon. The instructions are executed by the processors to implement a chat-window display module including instructions that when executed by the one or more processors permit a user to authenticate using natural language during a smart sign-in step and which prompt the user to register for a service that hosts the chat-window display module using natural language during a smart registration step.

### CROSS-REFERENCE TO RELATED APPLICATIONS

This application claims priority to U.S. Provisional Pat. Application 62/800,826 filed on Feb. 4, 2019.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to computer-based sign-in and registration technology, and more specifically to a smart sign-in and smart registration feature which takes place in a chat window-like experience. The present invention is directed to take the concept of a registration and login form but re-representing them in a Chat Window that users can use to interact with the website.

The present invention utilizes Smart Registration and Smart Login which are “chat” driven processes or methods which replace existing static registration and authentication form-based methods. Instead of a dedicated static page or pages to login or registration, the user is asked to register or sign-in via a chat window display. Additionally, the user may also be prompted to register for the service that hosts the chat window.

The present invention is thus an improvement for the convenience of the end user by facilitating the registration and/or sign-in process by using natural language to request authentication without knowledge of navigating a GUI based system. After the smart sign-In or registration is completed, the user can continue the conversation with the chatbot but with the availability of his or her account's contextual information.

### BRIEF DESCRIPTION OF THE DRAWINGS

The embodiments will be described in detail with reference to the following drawings in which like reference numerals refer to like elements wherein:

FIG. 1 shows a block diagram illustrating an example of a system for implementing various disclosed embodiments of the overall architecture of the smart sign-in and registration method and system of the present invention.

FIG. 1A shows a block diagram illustrating a simplified example of a system for implementing various disclosed embodiments of the overall architecture of the smart sign-in and registration method and system of the present invention.

FIG. 2A shows a schematic view of chat window of the registration portion of the smart sign-in and registration method and system of FIG. 1.

FIG. 2B shows a schematic view of chat window of the log in portion of the smart sign-in and registration method and system of FIG. 1.

FIG. 3 shows a flow diagram of the smart sign-in and registration method and system of FIG. 1.

FIG. 4 shows FIGS. 4A and 4B which comprise a schematic registration sequence diagram of the smart sign-in and registration method and system of FIG. 1.

FIG. 4A shows a partial schematic registration sequence diagram of the smart sign-in and registration method and system of FIG. 1.

FIG. 4B shows a partial schematic registration sequence diagram of the smart sign-in and registration method and system of FIG. 1.

FIG. 5 shows FIGS. 5A and 5B which comprise a schematic sign-in sequence diagram of the smart sign-in and registration method and system of FIG. 1.

FIG. 5A shows a partial schematic sign-in sequence diagram of the smart sign-in and registration method and system of FIG. 1.

FIG. 5B shows a partial schematic sign-in sequence diagram of the smart sign-in and registration method and system of FIG. 1.

FIG. 6 is a block diagram illustrating an example of a system for implementing various disclosed embodiments.

FIG. 7 is a block diagram illustrating an example network environment, in which various example embodiments may operate.

FIG. 8 is a block diagram illustrating an example computing system architecture, which may be used to implement a server or a client system.

### DETAILED DESCRIPTION

### Introduction

Although the aspects of the present invention are described below with reference to specific example embodiments, it will be evident that various modifications and changes may be made to these embodiments without departing from the broader spirit and scope of the invention. Accordingly, the specification and drawings are to be regarded in an illustrative rather than a restrictive sense. In particular, although the present disclosure is focused on various embodiments of mobile applications, the following provides an overview of an interactive networking system which describes features of an example network-deployed application applicable to both mobile and non-mobile settings.

A variety of types and configurations of a mobile computing device may be configured for executing instructions in connection with an application deployed on the mobile computing device. Mobile computing devices include but are not limited to portable, self-powered devices such as smartphones, PDAs, media players, and tablet computers. One or more applications may be provided to users on the mobile computing device through either a standalone software application, or as an internet-based application. As a further example, the mobile device application may be provided as a downloadable mobile software application (commonly referred to as an “app”) for execution on specific software platforms such as the Apple iOS operating system, or the Google Android operating system.

While the terms “mobile” and “non-mobile” versions are used throughout, it will be understood by one skilled in the art with the benefit of Applicants' disclosure that the disclosed techniques may be equally applicable to applications in general (e.g., productivity applications, expense applications, and the like) and not limited to just registration applications. As will equally be understood by one skilled in the art with the benefit of Applicants' disclosure, these techniques may be equally applicable to connectivity and features (e.g., cross promotions, rewards, communications, and the like) between two different applications—either two different instances of the same application executing on different application platforms (e.g., the same application running on Android and Windows) or two different applications which may or may not be executing on the same platform.

### Overall Architecture

This invention relates to a system and method for smart sign-in and registration 10 which takes place in a chat window-like experience.

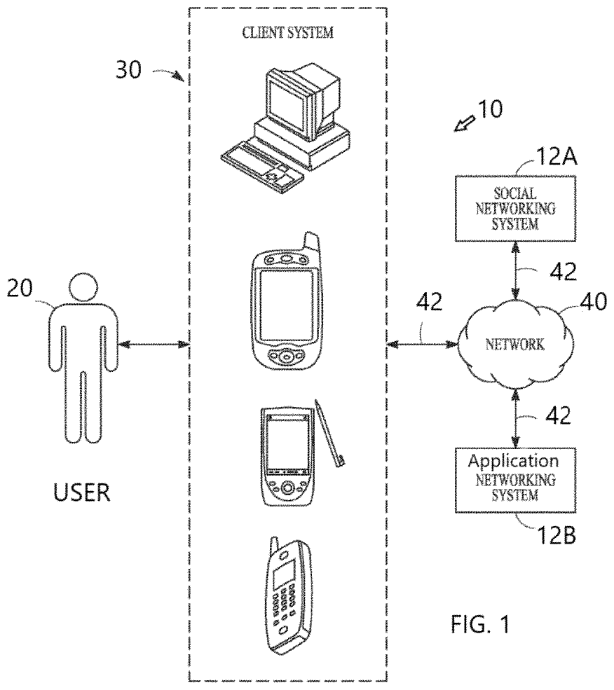

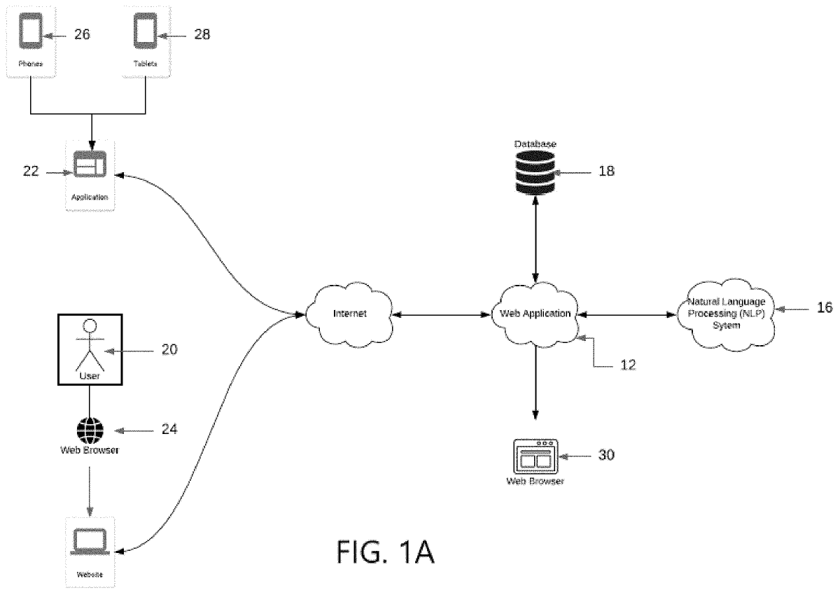

FIG. 1 illustrates an example of a system for implementing various disclosed embodiments. In particular embodiments, system 10 comprises user 20, social network system 12A, and application networking system 12B, client system 30, and network 40. The components of system 10 can be connected to each other in any suitable configuration, using any suitable type of connection. The components may be connected directly or over a network 40, which may be any suitable network. For example, one or more portions of network 40 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social network system 12A is a network-addressable computing system that can host one or more social graphs. Social networking system 12A can generate, store, receive, and transmit social networking data. Social network system 12A can be accessed by the other components of system 10 either directly or via network 40. Application networking system 12B is a network-addressable computing system that can host one or more online applications. Application networking system 12B can generate, store, receive, and transmit application-related data, such as, for example, application account data, application input, application state data, and application displays. Application networking system 12B can be accessed by the other components of system 10 either directly or via network 40. User 20 may use client system 30 to access, send data to, and receive data from social network system 12A and application networking system 12B. Client system 30 can access social networking system 12A or application networking system 12B directly, via network 40, or via a third-party system. As an example and not by way of limitation, client system 30 may access application networking system 12B via social networking system 12A. Client system 30 can be any suitable computing device, such as a personal computer, laptop, cellular handset, smart phone handset, computing tablet, and the like.

Although FIG. 1 illustrates a particular number of users 20, social network systems 12A, application networking systems 12B, client systems 30, and networks 40, this disclosure contemplates any suitable number of users 20, social network systems 12A, and application networking systems 12B, client systems 30, and networks 40. As an example, and not by way of limitation, system 10 may include one or more application networking systems 12B and no social networking systems 12A. As another example and not by way of limitation, system 10 may include a system that comprises both social networking system 12A and application networking system 12B. Moreover, although FIG. 1 illustrates a particular arrangement of user 20, social network system 12A, application networking system 12B, client system 30, and network 40, this disclosure contemplates any suitable arrangement of user 20, social network system 12A, application networking system 12B, client system 30, and network 40.

The components of system 10 may be connected to each other using any suitable connections 42. For example, suitable connections 42 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 42 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 42 need not necessarily be the same throughout system 10. One or more first connections 42 may differ in one or more respects from one or more second connections 42. Although FIG. 1 illustrates particular connections between user 10, social network system 12A, application networking system 12B, client system 30, and network 40, this disclosure contemplates any suitable connections between user 20, social network system 12A, application networking system 12B, client system 30, and network 40. As an example, and not by way of limitation, in particular embodiments, client system 30 may have a direct connection to social network system 12A or application networking system 12B, bypassing network 40.

### Mobile Device Applications

As used throughout the present disclosure, the term “mobile version” is generally distinguished from the term “non-mobile version.” A mobile version of a chat application is generally a software application that is tailored or customized for use with mobile computing devices. Mobile computing devices include smartphones, PDAs, tablets, media players, and other computing devices that are generally characterized as being portable and having smaller screens and operating capabilities than traditional desktop or notebook personal computer systems. The terms “mobile version” and “non-mobile version” are provided for convenience in the following sections but do not require that a separate machine-readable software application is created for each version (although a separate machine-readable software application may be commonly deployed for different operating system environments existing for each type of mobile computing device).

Further, the same chat application may be packaged for execution on both a desktop personal computer and a mobile computing device; in such a scenario a “mobile version” refers to the set of gaming functionality or features that is provided via identified mobile devices, in contrast to a not fully overlapping set of gaming functionality or features that is provided in the “non-mobile version.” As another non-limiting example, a “mobile version” might comprise a standalone software application “app” downloaded from a mobile device application store or market, whereas the “non-mobile version” might comprise a software application running in a browser, potentially in connection with display on a social networking website or a chat website.

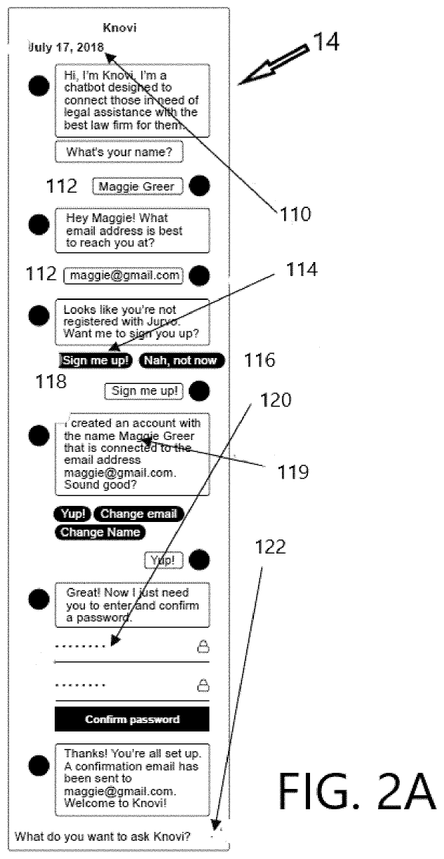

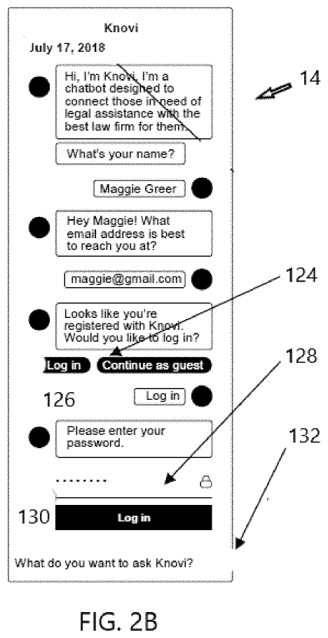

Referring now to FIGS. 1, 1A, 2A, and 2B, the system/application 10 typically takes the form of mobile application or website accessible software. The system 10 typically includes a WebApp 12, a ChatWindow 14, a Natural Language Processing (NLP) System 16, a Database 18 as the major components. Users typically consume the web pages or JSON responses from the WebApp 12 using various internet enabled devices, such as Laptops, Desktop, Mobile Phones, Tablets, and the like, as described in greater detail below.

The WebApp 12, NLP component 16 and Database 18 are abstracted into one “Application” 10. This Application 10 is responsible for all business logic in the present invention.

The WebApp 12 is a backend Web Application that is responsible for executing business logic. The WebApp 12 is typically not visible to the user and is typically a server-side application. The WebApp 12 is capable of receiving messages from the User 20 via a browser, a mobile application 22, or the ChatWindow 14 directly.

The Chat Window 14 is typically a frontend asset. In this context, the Chat Window 14 is a window on a web page served by the Web Application 12, though other forms of the invention are contemplated. The Chat Window 14 is capable of accepting user input and can display messages communicated from the WebApp 12.

Natural Language Processing (NLP) System 16 is typically a separate service from the WebApp 12 though other forms of the invention are contemplated and fall within the scope of the invention. Typically, the NLP system 16 is not a sub-component of the WebApp 12.

The Internal Database 18 stores user generated data. It is typically only accessible from the WebApp 12. In one form of the invention, the user 20 cannot directly communicate with this service.

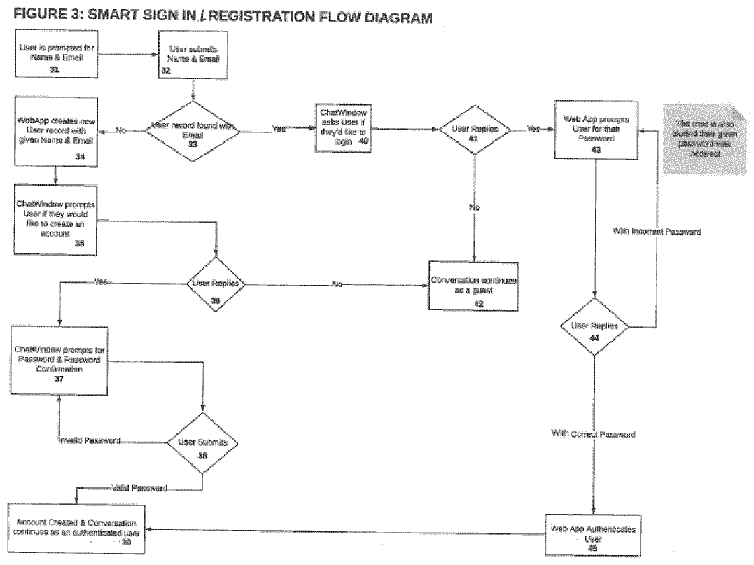

Referring now to FIG. 3, there is shown a flow diagram of the user's interaction via the ChatWindow 14 with the Smart Sign-In\Smart Registration application 10. In this case, the flow is describing the available choices to the user 20 and the state of the application 10 as the user 20 move through each feature. The flow diagram assumes that the context is that the user 20 is asked for his or her Name & Email immediately. Other possibilities exist and fall within the scope of the present invention.

### Smart Registration Context

Referring now to FIGS. 2A and 3, in Step 30, the User 20 is first presented with a prompt 110 to provide his or her Name & Email via the ChatWindow 14. In Step 31 the User 20 submits his or her Name & Email 112 into the ChatWindow 14. In Step 32 The Application 10 looks up the user's email in database 18. In Step 33 if the Application 10 does not find a user record with that particular email, the Application 10 prompts 114 the user to respond if they would like an account to be created in Step 33. In Step 36 the User 20 replies 116 to the question presented in Step 35. If the User 20 replies with assent 118, the ChatWindow 14 prompts 119 for Password & Password Confirmation in Step 37. In Step 38 the User 20 submits 120 his or her Password & Password Confirmation. Finally, in Step 39 the User's account is created, authenticated, and the User 20 is prompted 122 to continue the conversation.

### Smart Sign in Context

In Step 40, the Application 10 finds an account with the User's email (see Step 33 above) and asks 124 the User 20 if he or she would like to login. In Step 41 the User 20 replies 126 to the prompt confirming the intent to authenticate. If instead the User 20 expresses an intent to not login 124, the ChatWindow 14 continues the conversation without in the “Guest” context as in Step 42. In addition, the same result is reached when the User 20 expresses a negative intent to prompt in Step 36 above. Given the prompt as in Step 41, if the User 20 expresses a positive intent 126 in response, in Step 43, the WebApp 12 prompts 128 the User 20 for his or her Password. In Step 44 The User 20 replies 130 to the Password Prompt. Finally, in Step 45 if the User's reply (in Step 44) is the correct password for the account, the Application 10 authenticates 132 the User 20 and the ChatWindow 14 continues the Conversation as that authenticated User.

### Smart Registration Sequence Diagram

Referring now to FIGS. 1-4, 4A, and 4B where like reference numerals refer to like elements, the communications between the components of the application/system/service 10 that perform Smart Registration on behalf of the user 20 will be explained in greater detail. At the end of the Smart Registration Process, the user 20 will have registered with the application/system/service 10 as a new User and have his or her account stored in the service's Database 18.

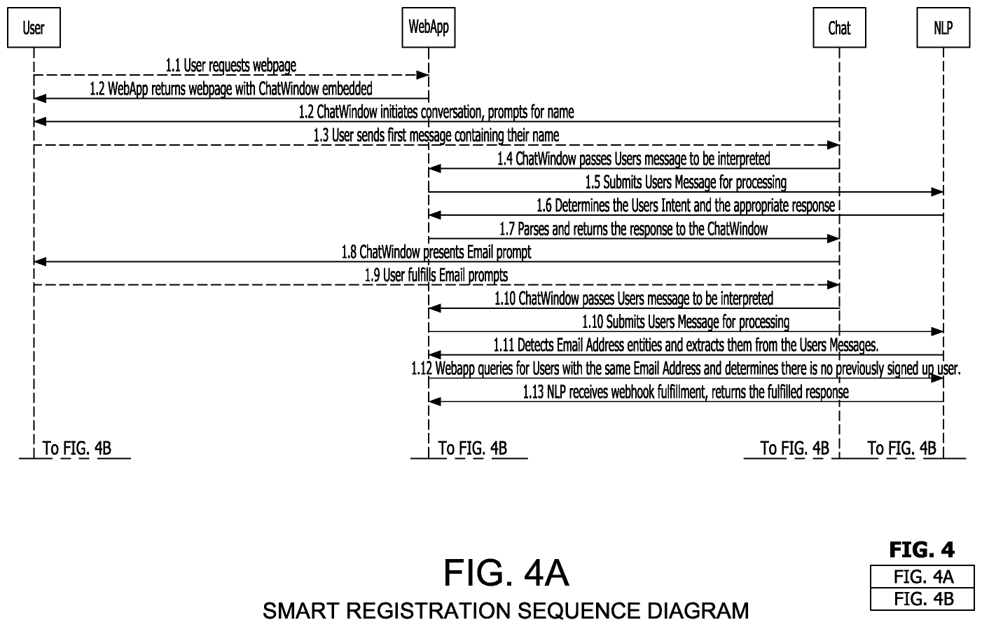

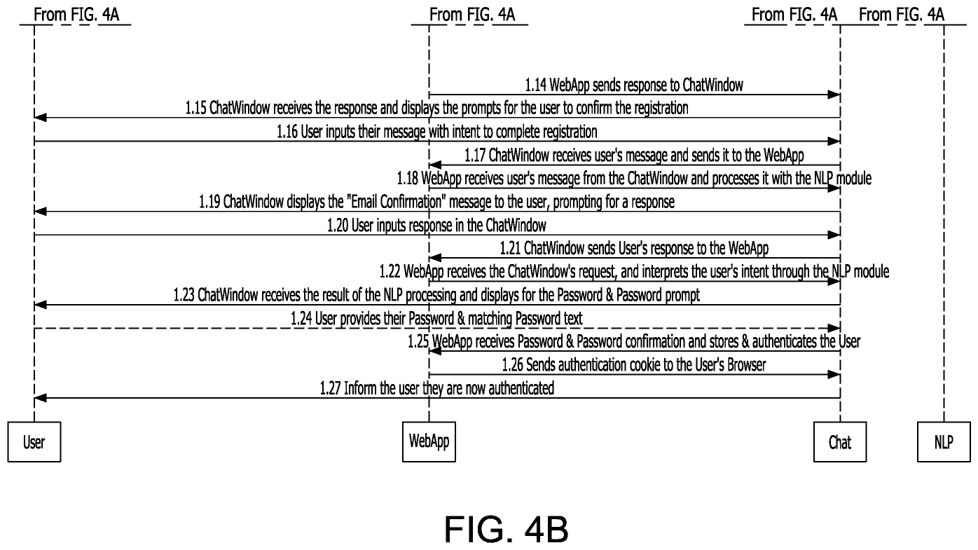

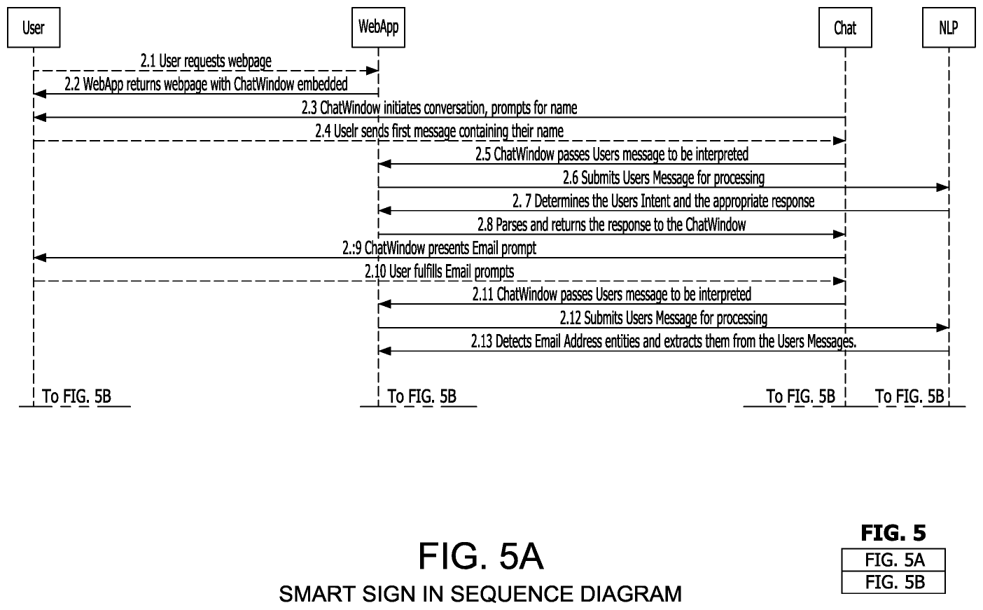

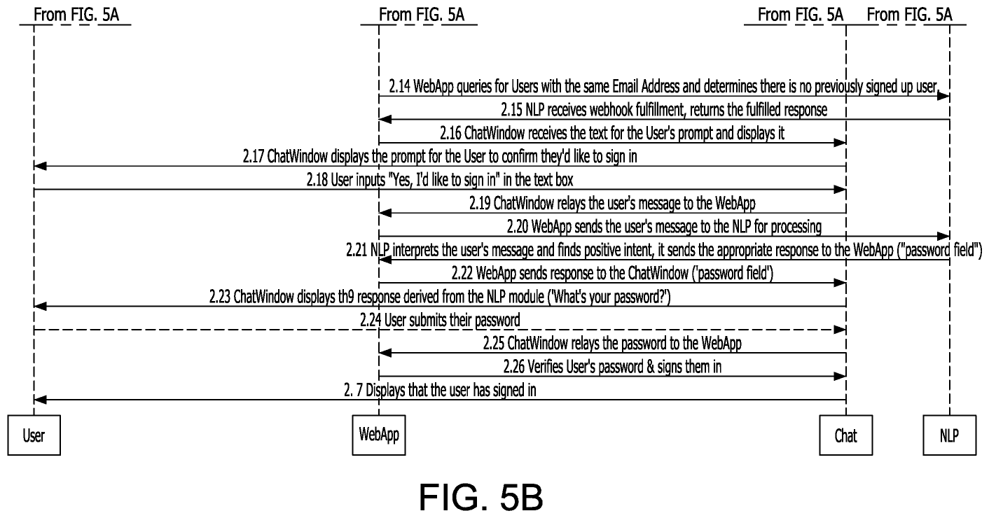

Referring now to FIGS. 4A and 4B, In Step 1.1, the User 20, using a browser 24, handset 26, tablet 28 or any similar device having similar functionality and in which includes a Web Browser requests a web page 30 from the Web Application 12. In Step 1.2, the Web Application 12 receives the browser's request and renders an HTML or similar document which contains an embedded Chat Window code. When the user's browser 24 receives this HTML document, it renders the Chat Window 14 and prompts the User 20 for input. For example, the prompt may be: “Hi I'm Knovi. I'm a chatbot designed to connect those in need of legal assistance with the best law firm for them. Could I have your name?”

In step 1.3, the user 20 inputs in a query into the Chat Window 14, such as, for example, the input: “Maggie Greer.” In step 1.4 The ChatWindow 14 typically uses the HTTP protocol to send a JSON message to the WebApp 12 to send the user's message. Below is an example of a typical payload:

{

“user_message”: “Maggie Greer”,
“Field_type”: “text”

}

In step 1.5, the WebApp 12 receives the user's message typically via the JSON payload. The WebApp 12 parses this content and processes it via the NLP component 16. In step 1.6, The NLP component 16 determines the user's intent. In the context of the present invention, the “intent” is a definition of a collection of training phrases, after the model has been trained on these phrases, the model will detect the user's intent from the original message. The NLP component determines whether the user's message contains a given name and a surname. If so, these parameters are parsed from the user's message. Typically, the intent includes a response definition which is plaintext that responds to the user's query directly. For example, the response definition for “Seeking Lawyer” could be “Sure, I can get you in touch with one of our lawyers. First could you sign up with us?” An example of a typical response from the NLP component 16 is as follows:

{

″Given_message″: ″Maggie Greer″,
″Detected_intent″: ″User Name″,
″Confidence″: 95.0,
″Response″: ″Hi Maggie! What email address is best to

reach you at?″,

″Context″: ″name-fulfilled″,
“Parameters”: {

“FirstName”: “Maggie”,
“LastName”: “Greer”

},
“FieldType”: “text”

}

In step 1.7, the WebApp 12 uses the “Response” field from the NLP's determination and passes it forward to the ChatWindow 14. AT this point, the first HTTP request from the ChatWindow to the WebApp is complete. In step 1.8 The ChatWindow 14 receives the HTTP response and populates the Chat Window's reply with the “Response” content, such as: “Hi Maggie! What email address is best to reach you at?” In step 1.9, the user 20 sees the response in the ChatWindow 14 and inputs his or her email address. For example, this user may provide a suitable email address, such as “maggie@gmail.com.” In step 1.10 The ChatWindow 14 uses the user's input to craft and send a JSON payload to the WebApp 12 containing the user's exemplary response:

{

“user_message”: “maggie@gmail.com”,
“Field_type”: “text”

}

In step 1.11, the WebApp receives the ChatWindow's HTTP message and parses the JSON payload. It passes the “user_message” property to the NLP component 16. The NLP component 16 has the context of “name-fulfilled” when the message of “maggie@gmail.com” is received, so NLP component 16 is aware to look for email addresses in ensuing messages from the user 20. In this way, the NLP component 16 parses the email address from the user's message and the result of the processing will return an exemplary data structure as follows:

{

“Given_message”: “maggie@gmail.com”,
“Detected_intent”: “User Email”,
“Confidence”: 95.0,
“Response”: “<to be fulfilled by webapp>”,
“Context”: [“name-fulfilled”, “email-fulfilled”]
“Parameters”: {

“Name”: “Maggie Greer”,
“Email”: “maggie@gmail.com”

}

}

The “User Email” intent is different from the other intent in that it requires a database look up to determine the resulting context. For Smart Registration, the user 20 with the email address of “maggie@gmail.com” does not yet exist. After that status has been determined, the ChatWindow 14 prompts for confirmation to create the user's account. However, for Smart Sign In (described in greater detail below), the user with the email address of “maggie@gmail.com” does exist in the user's table. After that user has been found, the ChatWindow 14 will instead prompt to inform the user 20 that he or she has been signed in. Before the data is passed back to the WebApp, the NLP component 16 requests the WebApp 12 to fulfill the “Response” text via a webhook to the WebApp 12.

In Step 1.12, The NLP module 16 sends the fulfillment webhook containing the above payload to the WebApp 12. The WebApp 12 receives the payload and checks for the “Detected Intent” and determines that the “Detected Intent” is “User Email.” This triggers the WebApp 12 to query the Database 18 to look up if any users are recorded with the email given in the “Parameters[‘Email’]” property. With a SQL database this query would look as follows in the present example:

SELECT * FROM users WHERE email = “maggie@gmail.com”

This particular query returns an empty dataset because the user 20 is being registered in this Smart Registration portion of the invention. Because the dataset is empty—the WebApp 12 fulfills the NLP 16 webhook by typically returning a JSON response to the webhook HTTP request that includes a typical response of “Looks like you're not registered with Knovi. Would you like me to sign you up?” In addition, because the WebApp 12 has determined this user is new, the WebApp 12 sets the context to “user-registration-email-fulfilled”. Below is the example of a typical response to the webhook request from the NLP component:

{

“Response”: “Looks like you're not registered with

Jurvo. Would you like me to sign you up?”,

“Context”: “user-registration-email-fulfilled”

}

In step 1.13, the NLP module 16 receives this request and overrides its “Response” parameter in turn with the given “Response” from the WebApp 12. One typical response in the present example is:

{

“Given_message”: “maggie@gmail.com”,
“Detected_intent”: “User Email”,
“Confidence”: 95.0,
“Response”: “Looks like you're not registered with

Jurvo. Would you like me to sign you up?”,

“Context”: “user-registration-email-fulfilled”,
“Parameters”: {

“Name”: “Maggie Greer”,
“Email”: “maggie@gmail.com”

},
“Field_type”: “text”

}

This payload is sent to the WebApp 12 in the same fashion as described in step 1.16 below. In Step 1.14, The WebApp 12 receives the payload from the NLP component and forwards it to the ChatWindow 14. The ChatWindow's HTTP request is now complete. In Step 1.15, The ChatWindow 14 displays the prompt from the “Response” in the JSON payload. This prompts the user 29 to confirm if he or she would like to continue the registration process. In Step 1.16 The user 20 typically expresses his or her intent to sign up by typically typing “Sign me up!” or similar expression of assent and enters it in the ChatWindow 14. In Step 1.17 The ChatWindow 14 sends the user's response to the WebApp, as follows:

{

“User_message”: “Sign me up!”,
“Field_type:

}

In Step 1.18, the WebApp 12 receives the ChatWindow's request with the “User_message” payload and forwards it to the NLP component 16. The NLP component interprets “Sign me up!” as a “User Registration—Confirmed” intent because the phrase “Sign me up!” is a training phrase contained in the database 18. The NLP's context and intent is thus updated to the “User Registration Confirmed” step, as follows:

{

“Given_message”: “Maggie Greer”,
“Detected_intent”: “User Name”,
“Confidence”: 95.0,
“Response”: “Hi Maggie! What email address is best to

reach you at?”,

“Context”: “name-fulfilled”,
“Parameters”: {

“FirstName”: “Maggie”,
“LastName”: “Greer”

},
“FieldType”: “text”

}

This payload is now forwarded to the ChatWindow 14 and the HTTP request from the ChatWindow 14 is complete. In Step 1.19, ChatWindow 14 typically displays the “Response” property for the user 20 as follows: “I created an account with the name Maggie Greer that is connected to the email address maggie@gmail.com. Sound good?” In Step 1.20, the user 20 would typically enter in a “Yup!” or similar assent message, expressing positive intent into the ChatWindow 14.

In Step 1.21, the ChatWindow 14 sends the User's response to the WebApp 12 typically in a JSON payload, as follows:

{

“User_message”: “Yup!”,
“Field_type”: “text”

}

In Step 1.22, the WebApp 12 receives the ChatWindow's HTTP request containing the payload. the WebApp 12 next passes the “User_message” property to the NLP component 16. In turn the NLP component 16 interprets the message to express the “User Registration Email Confirmed” intent. This intent is significant because it signals to override the default text field on the ChatWindow with a “password” field instead. At this point, the ChatWindow 14 is sent a payload that typically contains the following points:

{

“Given_message”: “Yup!”,
“Detected_intent”: “User Registration Email Confirmed”,
“Confidence”: 95.0,
“Response”: “Great! Now I just need you to enter and

confirm a password:”,

“Context”: “user-registration-email-confirmed-

fulfilled”

“Parameters”: {

“Name”: “Maggie Greer”,
“Email”: “maggie@gmail.com”

},
“Field_type”: “password_registration”

}

In Step 1.23, the ChatWindow 14 receives the JSON payload from the user 20. The ChatWindow 14 determines that the “Field_type” property is a “password” property and displays two (2) text fields for entering the Password & Password Confirmation fields. It also creates a new button to “Confirm Password.” This new display is rendered to the user 20 on the ChatWindow 14 to prompt the User to submit their Password for their new account as best seen in FIG. 2. In Step 1.24 The user 20 submits his or her Password & Password Confirmation inputs via the ChatWindow 14 password fields. The ChatWindow 14 then sends the captured information to the WebApp 12 typically in a JSON payload, as follows:

{

“password”: “letmein!”,
“Password_confirmation”: “letmein!”
“Field_type”: “password_registration”

}

The “Field_type” is also set in Step 1.23. In this way, the ChatWindow 14 is now aware of how to set the properties on the JSON request. In Step 1.25, the WebApp 12 receives the payload described in step 1.24. Because the “Field_type” has been set as “password_registration” the WebApp 12 is capable of determining whether to create a new user record from the existing parameters and the password provided from the user. With a SQL database 18 the query would be executed as follows:

INSERT INTO users (name, email, password) VALUES (‘Maggie
Greer’, ‘maggie@gmail.com’, ‘<encrypted letmein! password’)

The User's session is next authenticated. Cookies are typically used to track the user's session will reflect that the current user is ‘maggie@gmail.com,’ but other tracking schemes are known and suitable for use in the present invention. Next, the NLP component 16 is sent the user's response and updates the context & response text, as follows:

{

“Given_message”: “Yup!”,
“Detected_intent”: “User Registration Completed”,
“Confidence”: 95.0,
“Response”: “Thanks! You're all set up. A confirmation

email has been sent to maggie@gmail.com. Welcome to
Jurvo!”,

“Context”: “user-registration-completed-fulfilled”
“Parameters”: {

“Name”: “Maggie Greer”,
“Email”: “maggie@gmail.com”,
“Password”: “letmein!”,
“Password_confirmation”: “letmein!”

},
“Field_type”: “text”

}

In step 1.26, the ChatWindow 14 next receives this response and updates its display to revert back to a text field input to render the “Response” and continue the conversation.

In step 1.27, the user 20 is informed that they are authenticated by the system 10.

### Smart Sign in Sequence Diagram

Referring now to FIGS. 1-3 5A, and 5B where again like reference numerals refer to like elements, the communications between the components of the application/system/service 10 that perform Smart Sign-in on behalf of the user 20 will be explained in greater detail. The result of this Smart Sign-in process is that an existing user is capable of signing into his or her account through the Chat Window 14.

In step 2.1, the User 20, using a browser 24, handset 26, tablet 28 or any similar device having similar functionality, and in which includes a Web Browser requests a web page 30 from the Web Application 12. In Step 2.2, the Web Application 12 receives the browser's request and renders an HTML, or similar, document which contains an embedded Chat Window code. When the user's browser 24 receives this HTML document, it renders the Chat Window 14. In Step 2.3, after the browser 24 has rendered the ChatWindow 14, Chat Window 14 displays the initial prompt to the user 20. For example, “Hi I'm Knovi. I'm a chatbot designed to connect those in need of legal assistance with the best law firm for them. Could I have your name?” In Step 2.4, the user 20 inputs in response into the Chat Window 14 a suitable response, such as “Maggie Greer.” In Step 2.5, the ChatWindow 14 uses the HTTP protocol to typically send a JSON message to the WebApp 12 to send the user's message. Below is an example of the exemplary payload:

{

“user_message”: “Maggie Greer”,
“Field_type”: “text”

}

In Step 2.6, the WebApp 12 receives the user's message via the JSON payload. The WebApp 12 parses this content, determines it is text input based on the “Field_type” property and looks for the text in the “user_message” field. In Step 2.7, the WebApp 12 sends the “user_message” to the NLP component 16. Where the NLP component 16 determines the user's intent. As described above, an “intent” is a definition of a collection of training phrases, after the model has been trained on these phrases it detects the user's intent from the original message. The NLP component 16 determines whether the user's message contains a given name and a surname. These parameters are then parsed from the user's message. The intent includes a response definition. This is typically plaintext that responds to the user's query directly. For example, the response definition for “Seeking Lawyer” could be “Sure, I can get you in touch with one of our lawyers. First could you sign up with us?”

In this case, the user 20 has sent their full name as a response. The NLP component 16 recognizes that the text given contains a first name and a last name. The follow is an example of a response from the NLP component given the exemplary “Maggie Greer” input:

{

″Given_message″: ″Maggie Greer″,
″Detected_intent″: ″User Name″,
″Confidence″: 95.0,
″Response″: ″Hi Maggie! What email address is best to

reach you at?″,

″Context″: ″name-fulfilled″,
“Parameters”: {

“FirstName”: “Maggie”,
“LastName”: “Greer”

},
“FieldType”: “text”

}

This response is then sent back to the WebApp 12 for further processing.

In Step 2.8, the WebApp 12 uses the “Response” field from the NLP's determination and passes it forward to the ChatWindow 14. The first HTTP request from the ChatWindow 14 to the WebApp 12 is now complete.

In Step 2.9, the ChatWindow 14 receives the HTTP response and populates the Chat Window's reply with the “Response” content: “Hi Maggie! What email address is best to reach you at?” in Step 2.10, the user 20 sees the response displayed in the ChatWindow 14 and inputs his or her email address. For example, user 20 may respond with “maggie@gmail.com.”

In Step 2.11, the ChatWindow uses the user's input to craft and send a JSON payload to the WebApp 12 containing the user's response as follows:

{

“user_message”: “maggie@gmail.com”,
“Field_type”: “text”

}

In Step 2.12, the WebApp 12 receives the ChatWindow's HTTP message and parses the JSON payload. It passes the “user_message” property to the NLP component. In Step 2.13, The NLP component 16 receives the message and has the context of “name-fulfilled” when the message of “maggie@gmail.com” is received, so NLP component 16 is aware to look for email addresses in the next message. NLP component 16 parses the email address from the user's message. The end result of the processing will return a data structure similar to the following:

{

“Given_message”: “maggie@gmail.com”,
“Detected_intent”: “User Email”,
“Confidence”: 95.0,
“Response”: “<to be fulfilled by webapp>”,
“Context”: [“name-fulfilled”, “email-fulfilled”]
“Parameters”: {

“Name”: “Maggie Greer”,
“Email”: “maggie@gmail.com”

}

}

The “User Email” intent is different from the other intent in that it requires a database look up to determine the resulting context. For the Smart Sign-In process, the user 20 with the email address of “maggie@gmail.com” does exist in the user's table. After the user 20 has been located, the ChatWindow 14 instead prompts to notify the user 20 that he or she has been signed in. Before the data is passed back to the WebApp 12, ChatWindow 14 requests the WebApp 12 to fulfill the “Response” text via a webhook to the WebApp 12.

In Step 2.14, the NLP module 16 sends the fulfillment webhook containing the above payload to the WebApp 12. The WebApp 12 receives the payload and checks for the “Detected Intent” and determines that the “Detected Intent” is “User Email”. This triggers the WebApp 12 to query the Database 18 to look up if any users are stored with the email given in the “Parameters[‘Email’]” property. With a SQL database this query would look like the following:

SELECT * FROM users WHERE email = “maggie@gmail.com”

In this example of Smart Sign-In functionality, a single row is returned from this statement that corresponds to the user's account. Because the dataset is not empty—the WebApp 12 fulfills the NLP webhook by returning a JSON response to the webhook HTTP request that includes a typical response of “We've found an account with that email address. Would you like to sign in?”

In addition, because the WebApp 12 has now determined the user 20 is a returning, it will set the context to “pre-existing-user-fulfilled”. Below is a typical example of the response to the webhook request from the NLP component 16:

{

“Response”: “We've found an account with that email

address. Would you like to sign in?”,

“Context”: “pre-existing-user-fulfilled”

}

In Step 2.15, the NLP module 16 receives this request and overrides its “Response” parameter in turn with the given “Response” from the WebApp 12 as follows:

{

“Given_message”: “maggie@gmail.com”,
“Detected_intent”: “User Email”,
“Confidence”: 95.0,
“Response”: “We've found an account with that email

address. Would you like to sign in?”,

“Context”: “pre-existing-user-fulfilled”,
“Parameters”: {

“Name”: “Maggie Greer”,
“Email”: “maggie@gmail.com”

},
“Field_type”: “text”

}

This payload is sent to the WebApp 12 in the same fashion as described in connection with Step 2.6. In Step 2.16, the WebApp 12 receives the data from the NLP module 16 (See step 2.15) and renders it as a response to the request sent from the ChatWindow 14. In Step 2.17, the ChatWindow 14 receives the user's response as provided in Step 2.15 and it displays the “Response” field to the User 20. In Step 2.18, the User enters “Yes” or a similar form of assent into the ChatWindow 14. In Step 2.19, the ChatWindow 14 relays the user's message to the WebApp12 as follows:

{

“user_message”: “Yes”,
“Field_type”: “text”

}

In Step 2.20, the WebApp 12 receives the user's message and delivers the message to the NLP component 16 for processing. In step 2.21, the NLP component 16 receives the message described in connection with Step 2.19 and determines that the intent for this response is “User Sign In Confirmed” because “Yes” is one of the training phrases corresponding with the intent. An example is as follows:

{

“Given_message”: “maggie@gmail.com”,
“Detected_intent”: “User Sign In Confirmed”,
“Confidence”: 95.0,
“Response”: “Great. Please provide your password now

and I'll sign you in:”,

“Context”: “user-sign-in-confirmed-fulfilled”,
“Parameters”: {

“Name”: “Maggie Greer”,
“Email”: “maggie@gmail.com”

}

}

In Step 2.22, the WebApp 12 checks the intent of the NLP component 16 result. The WebApp 12 determines that the “User Sign-In Confirmed” intent requires a “password” field to fulfill the user's password on their next response. It appends “Field_type=password” on the response as follows:

{

“Given_message”: “maggie@gmail.com”,
“Detected_intent”: “User Sign In Confirmed”,
“Confidence”: 95.0,
“Response”: “Great. Please provide your password now

and I'll sign you in:”,

“Context”: “user-sign-in-confirmed-fulfilled”,
“Parameters”: {

“Name”: “Maggie Greer”,
“Email”: “maggie@gmail.com”

},
“Field_type”: “password”

}

This response is returned to the ChatWindow 14 and the HTTP request originating from the User's sign in confirmation is fulfilled. In Step 2.23, the ChatWindow 14 receives the JSON payload from the WebApp 12 described in Step 2.22. Because the “Field_type” of the property is set to “password,” the ChatWindow 14 is capable of determining whether to render a password input instead of a text input. In addition, the ChatWindow 14 presents the “Response” text as normal. In Step 2.24, The User 20 submits their account's password into the rendered password field. In Step 2.25, the ChatWindow 14 receives the input from the user and relays it to the WebApp 12 via an HTTP or similar request:

{

“user_message”: “letmein!”,
“Field_type”: “password”

}

In Step 2.26, the WebApp 12 receives the HTTP request from the ChatWindow 14 with the payload described in step 2.25. The WebApp 12 determines that the user 20 is submitting a password to attempt authentication because the “Field_type” is set to “password.” This signals the WebApp 12 to use the text given in the “user_message” field to populate the user's account. Next the WebApp 12 looks up the user's account from the conversation context provided by the NLP component 16 and authenticates the user 20. A cookie or other tracking mechanism is stored in the user's session that identifies the user 20, and the user 20 is logged into the service.

Below is a typical payload sent from the WebApp 12 in response to the ChatWindow's HTTP request:

{

″Given_message″: ″******″,
″Detected_intent″: ″User Sign In Completed″,
″Confidence″: 95.0,
″Response″: ″Thanks Maggie, you're now signed in. What

else can I help you with?″,

″Context″: ″user-sign-in-completed-fulfilled″,
″Parameters″: {

″Name″: ″Maggie Greer″,
″Email″: ″maggie@gmail.com″

},
“Field_type”: “text”

}

In Step 2.27, the ChatWindow 14 receives the JSON payload and renders the text field and “Response” property. The ChatWindow 14 also sets the cookie from the WebApp 12 to the user's browser 24 so the user's browser maintains the same session. Finally, in Step 2.28 The User 20 is now able to continue the conversation under the context of their account and its features, completing the Sign-in Process.

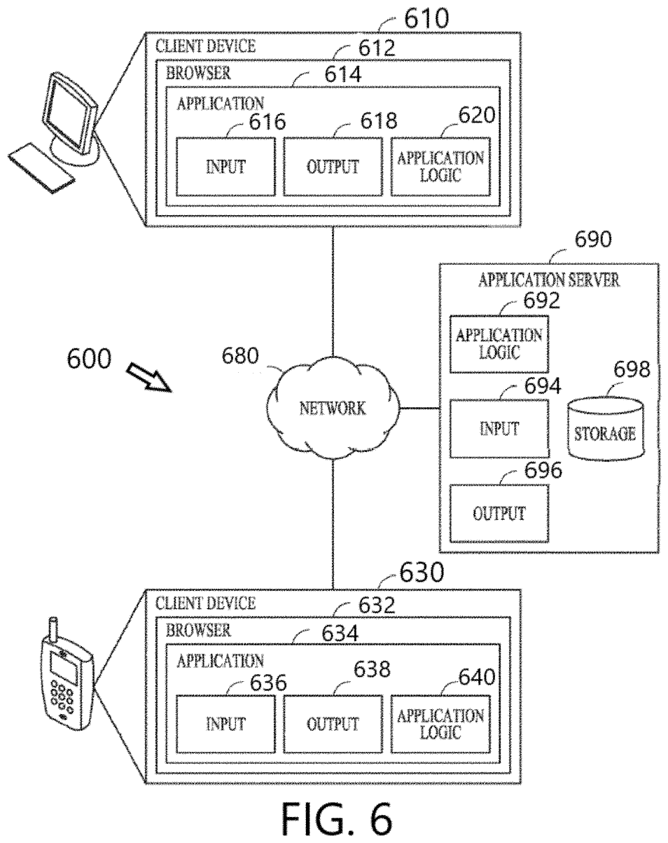

FIG. 6 shows an example system 600 configured to facilitate cross application chat-based services according to some examples of the present disclosure. Client device 610 may be a laptop, desktop, tablet, mobile device, or other computing platform. A computing platform may include a specific combination of computing hardware (e.g., computer processor, memory, display components, or the like) and the operating system which allows for applications to utilize this hardware. For example, client device 610 may be a desktop computer running the Microsoft Windows® family of operating systems provided by Microsoft Corporation of Redmond Wash., or a laptop running an OSX family of operating systems provided by Apple Computer, Inc., of Cupertino Calif. In some examples, client device 610 and client device 630 may be the same or different computing platforms. For example, client device 610 may be a laptop executing the Microsoft Windows or iOS operating systems, whereas the client device 630 may be a mobile device executing the Android operating system provided by Google, Inc., of Mountain View Calif., or running an iOS family of operating systems provided by Apple.

Client devices 610 and 630 may run various applications including browsers 612 and 632. Browsers 612, 632 may include Microsoft Internet Explorer, provided by Microsoft Corporation, Safari provided by Apple, Chrome provided by Google, or the like. Applications 614 and 634 may execute within browsers 612 and 632 and may be or include JavaScript, Flash, Silverlight, HyperText Markup Language (HTML), eXtensible Markup Language (XML), or other components, which when executed within browsers 612 and 632 may provide the functionality of applications 614 and 634, respectively. In other examples, applications 614 and 634 may be stand-alone applications not executed within browsers 612 and 632.

Applications 614 and 634 may be one or more applications such as chat applications, productivity applications, or the like. Applications 614 and 634 may include one or more modules. Applications 614 and 634 may be the non-mobile and mobile versions of the application respectively. Input modules 616 and 636 may allow for accepting and processing user input into the application and for receiving information over a network 680 from external sources such as application server 690 or other applications. Output modules 618, 638 may display output to a display device (e.g., Liquid Crystal Display, LED Display, OLED Display, or the like) according to commands issued by the application logic modules 620, 640. Application logic modules 620, 640 may control the output of the application and respond to one or more inputs of the application (delivered from the respective input modules) according to the rules and logic implemented in the application logic modules 620, 640. For example, in the case of a computer implemented application, the application logic modules 620, 640 may be a chat application logic module which implements the rules of the chat application.

Application logic modules 620, 640 may also communicate with application server 690 through output module 618 over network 680. Network 680 may be any network capable of allowing communication between client devices 610, 630 and application server 690. For example, network 680 may be or include part of the Internet, a Wide Area Network, a Local Area Network, a Cellular Network, or the like. Application logic modules 620, 640 may communicate application information to the application server 680. For example, application information may include application states, or progress. In some examples, application logic modules 620, 640 may contain all the logic necessary to provide applications 612, 632. In other examples, application logic modules 620, 640 may contain some of the logic necessary to provide applications 612, 632 and the rest of the logic may be provided by application module 692 of application server 690. Applications 612, 632 may send application state, user inputs, or other information to application server 690 for processing by application module 692. In response, application module 692 may provide applications 612, 632 with update application state information or other commands.

Application server 690 may contain an input module 694 to process information sent by client devices 610, 630 and an output module to send information to client devices 610, 630. In some examples the output module 696 may provide to client devices 610, 630 the application code for the applications 612, 632.

Application server 690 may include a storage device 698 for storing application information sent to applications 612, 632 or sent from applications 612, 632.

### System and Methods

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third-party application).

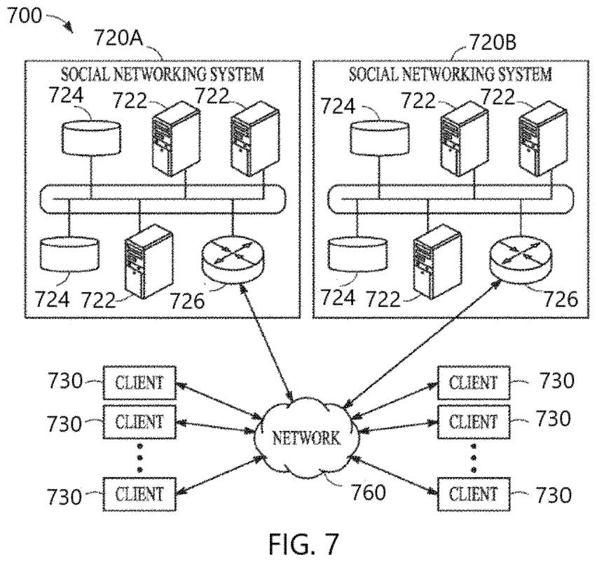

Particular embodiments may operate in a wide area network environment, such as the Internet, including multiple network addressable systems. FIG. 7 illustrates an example network environment 700, in which various example embodiments may operate. Network cloud 760 generally represents one or more interconnected networks, over which the systems and hosts described herein can communicate. Network cloud 760 may include packet-based wide area networks (such as the Internet), private networks, wireless networks, satellite networks, cellular networks, paging networks, and the like. As FIG. 7 illustrates, particular embodiments may operate in a network environment comprising one or more networking systems, such as social networking system 720A, application networking system 720B, and one or more client systems 730. The components of social networking system 720A and application networking system 720B operate analogously; as such, hereinafter they may be referred to simply at networking system 720. Client systems 730 are operably connected to the network environment via a network service provider, a wireless carrier, or any other suitable means.

Networking system 720 is a network addressable system that, in various example embodiments, comprises one or more physical servers 722 and data stores 724. The one or more physical servers 722 are operably connected to computer network 760 via, by way of example, a set of routers and/or networking switches 726. In an example embodiment, the functionality hosted by the one or more physical servers 722 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 722 may host functionality directed to the operations of networking system 720. Hereinafter servers 722 may be referred to as server 722, although server 722 may include numerous servers hosting, for example, networking system 720, as well as other content distribution servers, data stores, and databases. Data store 724 may store content and data relating to, and enabling, operation of networking system as digital data objects. A data object, in particular embodiments, is an item of digital information typically stored or embodied in a data file, database, or record. Content objects may take many forms, including: text (e.g., ASCII, SGML, HTML), images (e.g., jpeg, png, tiff, and gif), graphics (vector-based or bitmap), audio, video (e.g., mpeg), or other multimedia, and combinations thereof. Content object data may also include executable code objects (e.g., applications executable within a browser window or frame), podcasts, and the like. Logically, data store 724 corresponds to one or more of a variety of separate and integrated databases, such as relational databases and object-oriented databases, that maintain information as an integrated collection of logically related records or files stored on one or more physical systems. Structurally, data store 724 may generally include one or more of a large class of data storage and management systems. In particular embodiments, data store 724 may be implemented by any suitable physical system(s) including components, such as one or more database servers, mass storage media, media library systems, storage area networks, data storage clouds, and the like. In one example embodiment, data store 724 includes one or more servers, databases (e.g., MySQL), and/or data warehouses. Data store 724 may include data associated with different networking system users and/or client systems 730.

Client system 730 is generally a computer or computing device including functionality for communicating (e.g., remotely) over a computer network. Client system 730 may be a desktop computer, laptop computer, personal digital assistant (PDA), in- or out-of-car navigation system, smart phone/handset or other cellular or mobile handset, or mobile gaming device, among other suitable computing devices. Client system 730 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 730 to enter addresses of specific network resources to be retrieved, such as resources hosted by networking system. These addresses can be Uniform Resource Locators (URLs) and the like. In addition, once a page or other resource has been retrieved, the client applications may provide access to other pages or records when the user selects hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 730 desires to view a particular webpage (hereinafter also referred to as target structured document) hosted by networking system, the user's web browser, or other document rendering engine or suitable client application, formulates and transmits a request to networking system. The request generally includes a URL or other document identifier as well as metadata or other information. By way of example, the request may include information identifying the user, such as a user ID, as well as information identifying or characterizing the web browser or operating system running on the user's client computing device 730. The request may also include location information identifying a geographic location of the user's client system or a logical network location of the user's client system. The request may also include a timestamp identifying when the request was transmitted.

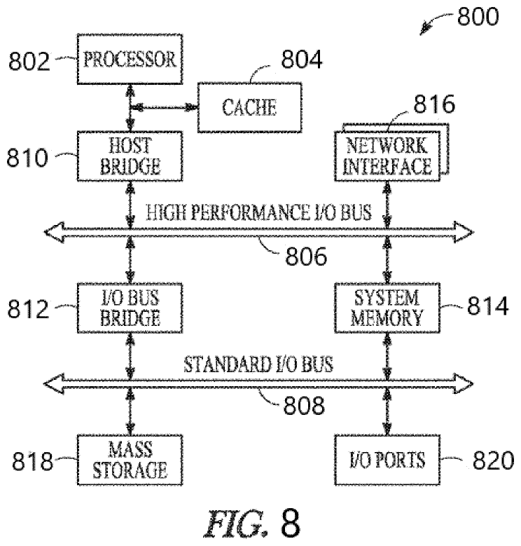

FIG. 8 illustrates an example computing system architecture, which may be used to implement a server 822 or a client system 830. In one embodiment, hardware system 800 comprises a processor 802, a cache memory 804, and one or more executable modules and drivers, stored on a tangible computer readable medium, directed to the functions described herein. Additionally, hardware system 800 may include a high performance input/output (I/O) bus 806 and a standard I/O bus 808. A host bridge 810 may couple processor 802 to high performance I/O bus 806, whereas I/O bus bridge 812 couples the two buses 806 and 808 to each other. A system memory 814 and one or more network/communication interfaces 816 may couple to bus 806. Hardware system 800 may further include video memory (not shown) and a display device coupled to the video memory. Mass storage 818 and I/O ports 820 may couple to bus 808. Hardware system 800 may optionally include a keyboard, a pointing device, and a display device (not shown) coupled to bus 708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 800 are described in greater detail below. In particular, network interface 816 provides communication between hardware system 800 and any of a wide range of networks, such as an Ethernet (e.g., IEEE 802.3) network, a backplane, and the like. Mass storage 818 provides permanent storage for the data and programming instructions to perform the above-described functions implemented in servers 822, whereas system memory 814 (e.g., DRAM) provides temporary storage for the data and programming instructions when executed by processor 802. I/O ports 820 are one or more serial and/or parallel communication ports that provide communication between additional peripheral devices, which may be coupled to hardware system 800.

Hardware system 800 may include a variety of system architectures and various components of hardware system 800 may be rearranged. For example, cache 804 may be on-chip with processor 802. Alternatively, cache 804 and processor 802 may be packed together as a “processor module,” with processor 802 being referred to as the “processor core.” Furthermore, certain embodiments of the present disclosure may not require nor include all of the above components. For example, the peripheral devices shown coupled to standard I/O bus 808 may couple to high performance I/O bus 806. In addition, in some embodiments, only a single bus may exist, with the components of hardware system 800 being coupled to the single bus. Furthermore, hardware system 800 may include additional components, such as additional processors, storage devices, or memories.

An operating system manages and controls the operation of hardware system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein may include or be embodied in logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

### Miscellaneous

One or more features from any embodiment may be combined with one or more features of any other embodiment without departing from the scope of the disclosure. A recitation of “a,” “an,” or “the” is intended to mean “one or more” unless specifically indicated to the contrary.

The present disclosure encompasses all changes, substitutions, variations, alterations, and modifications to the example embodiments herein that a person having ordinary skill in the art would comprehend. For example, the methods, application features and application mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of smart registration and sign-in comprising:
a smart sign-in step; and
a smart registration step.

2. The method of smart registration and sign-in according to claim 1 in which the smart sign-in step comprises a chat-window display which permits a user to authenticate using natural language.

3. The method of smart registration and sign-in according to claim 2, wherein the smart sign-in step further comprises the step of prompting the user to register for the service that hosts the chat window.

4. A method of smart registration according to claim 1 in which the smart registration step comprises a chat-window display which permits a user to authenticate using natural language.

5. A method of smart registration according to claim 4 wherein the registration step further comprises the step of prompting the user to register for the service that hosts the chat window.

6. A method of smart registration according to claim 2 in which the smart registration step comprises a chat-window display which permits a user to authenticate using natural language.

7. A method of smart registration according to claim 6 wherein the registration step further comprises the step of prompting the user to register for the service that hosts the chat window.

8. The method of smart registration and sign-in according to claim 6, wherein the smart sign-in step further comprises the step of prompting the user to register for the service that hosts the chat window.

9. The method of smart registration and sign-in according to claim 7, wherein the smart sign-in step further comprises the step of prompting the user to register for the service that hosts the chat window.

10. A non-transitory machine-readable medium that stores instructions which when performed by a client computing device, cause the client computing device to perform operations comprising:
generating a chat-window display module which permits a user to authenticate using natural language during a smart sign-in step and which prompts the user to register for a service that hosts the chat-window display module using natural language during a smart registration step.

11. A system, comprising: one or more processors; and one or more memory devices with instructions stored thereon, wherein the instructions are executed by the one or more processors to implement one or more modules, the one or more modules including:
a chat-window display module including instructions that when executed by the one or more processors permit a user to authenticate using natural language during a smart sign-in step and which prompt the user to register for a service that hosts the chat-window display module using natural language during a smart registration step.
